(19) United States
(12) Patent Application Publication
(10) Pub. No.: US 2011/0052147 A1
(43) Pub. Date: Mar. 3, 2011

(54) PLAYBACK OF VIDEO AND CORRESPONDING SUBTITLE DATA

(75) Inventors: Jagadish Murugan, Chennai (IN); Sunil Sridhara, Bangalore (IN); Narendranath Udupa, Bangalore (IN)

(73) Assignee: KONINKLIJKE PHILIPS ELECTRONICS N.V., EINDHOVEN (NL)

(21) Appl. No.: 12/446,279

(22) PCT Filed: Oct. 22, 2007
(86) PCT No.: PCT/IB07/54274

§ 371 Date: Nov. 8, 2010

(30) Foreign Application Priority Data
Oct. 25, 2006 (EP) 06122918.3

(51) Int. Cl. H04N 5/92

(52) U.S. Cl. 386/245; 386/E05.003

(57) ABSTRACT

The invention relates playing back video with subtitles. A playback apparatus (20) is provided for playback of video data (e.g. in DivX-format) and corresponding subtitle data files from a record carrier. The one or more subtitle data files may be stored on the carrier without language metadata of the subtitles. The apparatus comprises units operable to access the one or more subtitle data files on the associated record carrier, fetch a content sample (21-26) of the subtitle data files, and output to a display unit (3) a signal representing the fetched content samples. The user may then select one of the content samples and thus identify the desired subtitle file to be reproduced.

### FIELD OF THE INVENTION

The invention relates to playback of video data and corresponding one or more subtitle data files from an associated record carrier.

### BACKGROUND OF THE INVENTION

Digitally recorded movies are accessible in a number of formats, both in terms of coding formats and storage formats. The DivX format is a popular format. The DivX format usually offers a single language subtitle and not multi language subtitles, however the feature of external subtitle display provides a solution to this, since users who want to watch a movie with subtitles in a given language can do so if an external subtitle file is available. Typically a movie is provided with a number of external subtitle files in different languages.

External subtitle files are text files providing the time stamp and the subtitle string, but without information, such as metadata about language, character set, or coding format. When a user selects a subtitle, the subtitle strings will be decoded with respect to the current menu language and character setting of the playback device. The user will therefore see meaningless subtitles on the screen if the settings of the playback device, does not correspond to that of the external subtitle file. The user then needs to find the correct combination of external subtitle and setting of the playback device, which can be a frustrating, tedious and time consuming task.

Solutions of the prior art suggest to include metadata in connection with the available subtitle files, see e.g. U.S. Pat. No. 5,850,500 which discloses a reproduction apparatus being designed to select and decode subtitle characters in a given language from a disk on which various types of information are recorded in different languages.

### SUMMARY OF THE INVENTION

The inventor of the present invention has appreciated that for such formats as the DivX and possible other formats, the solution to the above-mentioned problems and possible other problems, is not to design an alternative coding format, but to improve the handling within existing formats or other formats with similar problems, and have in consequence devised the present invention. Preferably, the invention alleviates, mitigates or eliminates one or more of the above or other disadvantages singly or in any combination.

According to a first aspect of the present invention there is provided a playback apparatus for playback of video data and corresponding one or more subtitle data files from an associated record carrier, the one or more subtitle data files being stored without language metadata of the subtitles. The apparatus is configured in accordance with a first language setting and comprises:

a fetch unit operable, in response to a request action, to access the one or more subtitle data files on the associated record carrier and fetch a content sample of the subtitle data files;

an output unit for outputting to a display unit for the one or more subtitle data files, a signal representing the fetched content samples, the signal being generated based on the first language setting.

The invention is advantageously, but not exclusively, used in connection with playback of multimedia content in the DivX-format. A popular feature in DivX-playback is the external subtitle display. The first language setting of the apparatus may specify the menu language and the specific character set and possible other additional or alternative settings.

It is an advantage of the present invention, that an effective way is provided of outputting to a display unit a signal representing the fetched content samples, so that a user need not try out all the combinations of external subtitle and character set if the menu language and character set (i.e. the first language setting) does not correspond with that of the external subtitle file. Moreover, by providing an effective and direct way of outputting to a display unit a signal representing the fetched content samples, the number of field call rates with respect to external subtitle handling will be decreased.

In an advantageous embodiment, the apparatus may further comprise a selector unit being operable in response to a selection of one of the content samples, to configure the playback apparatus for playback using the subtitle data file corresponding to the selected content sample, thereby providing an even more effective way of handling correct subtitle display.

The request action may automatically be provided by the apparatus upon initiation of playback, so that the content samples are fetched in the initiation process and stored on a storage unit for later access. It may be advantageous to fetch the content samples during the initiation process since communication with the associated record carrier may add only little additional time to the initialization process, this may not be noticeable at initialization, but typically will at a later instance.

In an embodiment, when no match is obtained by the menu language setting, the language setting of the apparatus may be set to a second setting, thereby selecting a new character set, so that the signal representing the fetched content samples is generated based on the new character set. A user may thereby quickly try-out all different language settings in order to judge whether or not a subtitle file may be viewed in a meaningful way.

In a second aspect is provided a method of operating a playback apparatus in accordance with the first aspect. The method of the second aspect may in a third aspect be implemented in an integrated circuit (IC) for operating a playback apparatus of the first aspect, and may in a fourth aspect be implemented in computer readable code for operating a playback apparatus of the first aspect.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates a playback apparatus for playback of video data and corresponding one or more subtitle data files;

FIG. 2 schematically illustrates an embodiment of a user interface of a playback apparatus in accordance with the present invention;

FIG. 3 illustrates a schematic embodiment of a playback apparatus in accordance with the present invention; and

FIG. 4 illustrates a flow diagram of operating a playback apparatus for playback of video data and corresponding one or more subtitle data files from an associated record carrier.

### DESCRIPTION OF EMBODIMENTS

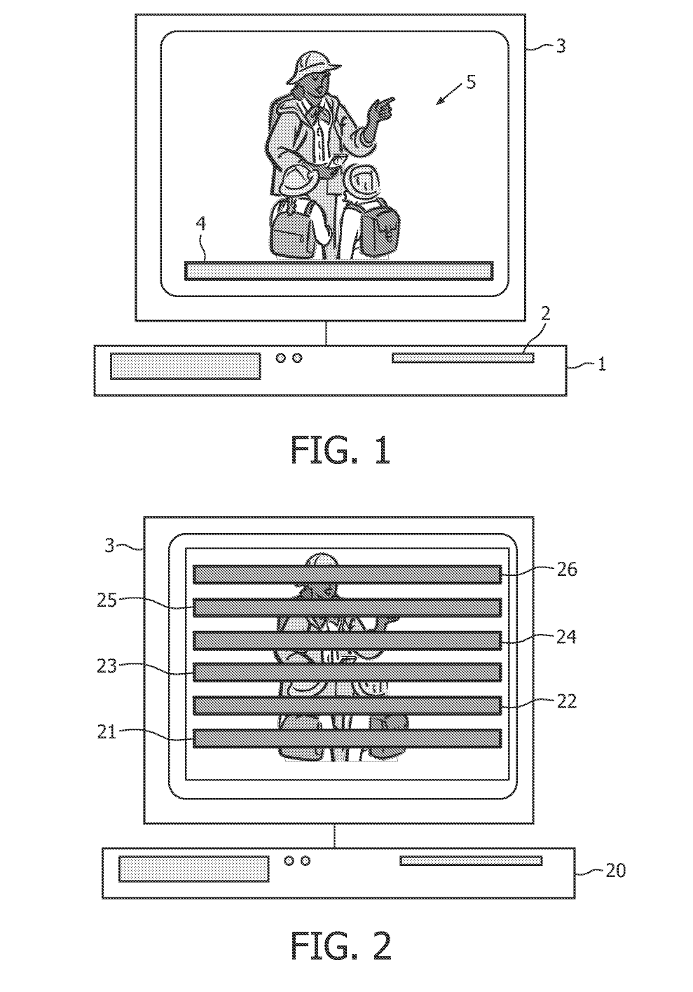

FIG. 1 illustrates a playback apparatus 1 for playback of video data 5 and corresponding one or more subtitle data files from an associated record carrier, here being from an optical record carrier inserted in a tray 2. The record carrier may be any type of storage device, including but not limited to a harddisk on a harddisk recorder, in a computer, in a media centre, etc. The apparatus may be an apparatus adapted with playback capability of the DivX video format. The record carrier contains the movie to be played and a number of subtitle data files, the subtitle data files being stored without language metadata of the subtitles. The video data and the one or more subtitle data files are typically stored in separate data files on the associated record carrier.

A user wishing to watch a movie, for example on a display screen 3, is presented with the movie and the subtitle 4 of the first one of the available files. For example, six subtitle data files may be available:

file 1: UTF-8 encoding, Japanese

file 2: UTF-8 encoding, Chinese

file 3: UTF-8 encoding, Korean

file 4: UTF-8 encoding, Turkish

file 4: UTF-8 encoding, Arabic

file 6: ISO-8859, English

The user may be an English user with a (first) language setting of the playback apparatus of ISO-8859. The various external subtitle files may be saved in a number of different formats, e.g. such formats as: SMI, MicroDVD, .SUB, .SSA, .ASS, .SRT. For DivX-players, a large number of formats are available.

Since the character settings of the first available file and the playback apparatus do not match, the shown subtitle 4 will be meaningless. As an illustrative example, the subtitle may appear to the user as:

Subtitle 1: Puo sdf*a mag{a dsfer j9; ;;..as
By pressing the subtitle key again, the next available file is accessed, again resulting in a subtitle which is meaningless:
Subtitle 2: ds f dfewå *;sd98 9f2 sdd5f .gw
The user may continue until the sixth title is read:
Subtitle 6: Kids we're lost! Let's go that way.
A user has to press the subtitle button 6 times in order to show the desired subtitles.

In a different situation, no matching subtitles are found, which may be due to that the playback apparatus does not support the possible character sets, or the setting of the playback apparatus is such that a match can not be obtained. In both situations a user may try changing the language setting of the apparatus and retry the above routine by checking each of the files subsequently, and hope for finding a match. This is quite a tedious task, and potentially very time-consuming and annoying even if a match is eventually found.

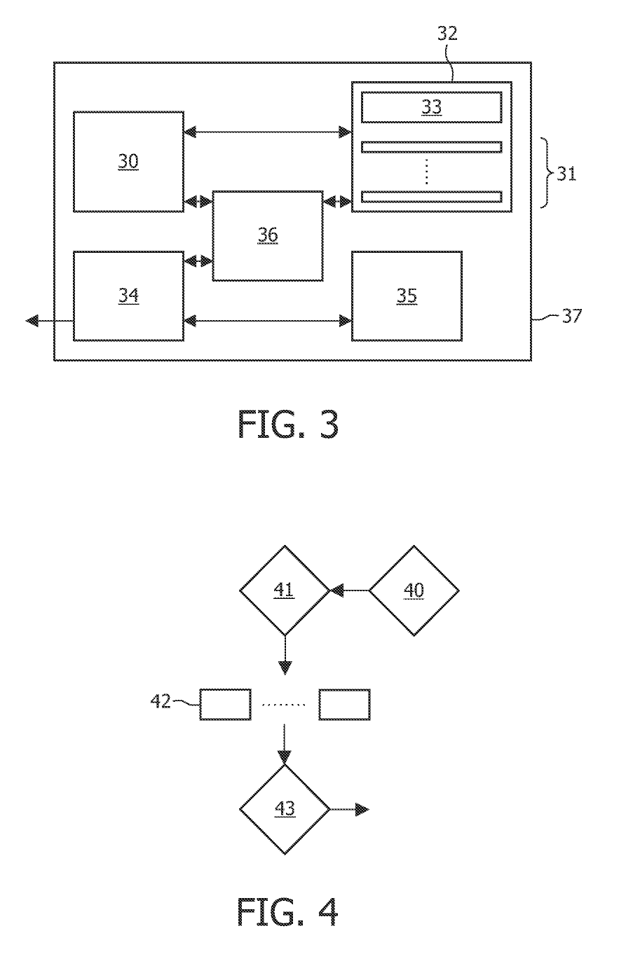

FIG. 2 illustrates an embodiment of a user interface of a playback apparatus 20 in accordance with the present invention, whereas FIG. 3 illustrates a schematic embodiment of a playback apparatus 37 in accordance with the present invention. Embodiments will now be described with reference both to FIGS. 2 and 3.

As illustrated in FIG. 3, a fetch unit 30 is arranged to, in response to a request action, such as a push on a given button on a remote control, to access the one or more subtitle data files 31 on the associated record carrier 32 and fetch a content sample of each subtitle data file. Also the movie 33 is stored on the record carrier. An output unit 34 for outputting the one or more subtitle data files to a display unit 3 is provided. The output is a signal representing the fetched content samples.

The content samples 21-26 may be the first line of the subtitle files, or other relevant part of the subtitle strings. The user is thereby able to see samples from all the files at one shot and so can select the correct format e.g. by pressing the index number of the subtitle, or by use of arrow keys. If more formats are supported than the number of subtitles that do fit in one page, a “next page” facility can be used.

The apparatus 20, 37 may comprise a selector unit 35 for configuring the playback apparatus for playback using the subtitle data file corresponding to the selected content sample.

In an embodiment of the apparatus 20, 37 the request action is automatically provided by the apparatus upon initiation of playback, so that the content samples are fetched in the initiation process and stored on the storage unit 36 for later access. When a movie file, such as a DivX file is selected for playback, the file is parsed for a lot of information. This process consumes an amount of time. The fetching of the contents samples will not add considerably to the total initialization time because only the following operation may be performed:

1. File open->O1

2. Read and store sample string (e.g. the first string)->02

The combination O1+O2 is in the order of milliseconds. It may be advantageous to perform the routine at start up, since there the added time is not noticed by the user, whereas if the combination of O1+O2 is performed as a consequence of pushing a button, the user may experience it as an annoying delay. However, in an embodiment, both possibilities may be available, so that the user may e.g. change the displayed subtitle during playback.

Many apparatuses support a number of language settings. For example, the Philips player 642K support Latin 1 and 2 and Latin Cyrillic character sets, and the Pioneer DV-470 support Latin 1 character sets. In the situation where none of the subtitles are displayed correctly, the language setting of the apparatus can be set to a second setting, and the displaying of the content samples can be repeated with the new language setting. This may be achieved by enabling the output unit to output to the display unit a signal representing the fetched content samples, the signal being generated based on the second language setting.

For a device supporting e.g. five formats, a user may from a known playback device be forced to tryout all five formats for a number of language settings. By application of the present invention, the total number of worst-case retries is reduced to one fifth, since all five formats are shown simultaneously.

FIG. 4 illustrates a flow diagram of operating a playback apparatus for playback of video data and corresponding one or more subtitle data files from an associated record carrier. A first language setting 40 is applicable for a player. In a first step 41, one or more subtitle data files on the associated record carrier are accessed and content samples 42 of the subtitle data files are fetched. A signal representing the fetched content samples are outputted 43 to a display unit for display and presentation to a user.

One or more elements or components of FIG. 3 and FIG. 4 may be implemented in one or more integrated circuit (IC), or as a part of an IC, for operating a playback apparatus, as well as be implemented in computer readable code for operating a playback apparatus.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

In summary, the invention relates to playing back video (e.g. in DivX-format) with subtitles. A playback apparatus (20) is provided for playback of video data and corresponding subtitle data files from a record carrier. The one or more subtitle data files may be stored on the carrier without language metadata of the subtitles. The apparatus comprises units operable to access the one or more subtitle data files on the associated record carrier, fetch a content sample (21-26) of the subtitle data files, and output to a display unit (3) a signal representing the fetched content samples. The user may then select one of the content samples and thus identify the desired subtitle file to be reproduced.

1. Playback apparatus (20, 37) for playback of video data (5, 33) and corresponding one or more subtitle data files (31) from an associated record carrier (32) on which said one or more subtitle data files are stored, the apparatus being configured in accordance with a first language setting (40), the apparatus comprising:
a fetch unit (30) operable, in response to a request action, to access the one or more subtitle data files on the associated record carrier and fetch a content sample (21-26, 42) of the subtitle data files;
an output unit (34) for outputting to a display unit (3) for the one or more subtitle data files, a signal representing the fetched content samples, the signal being generated based on the first language setting.

2. The apparatus according to claim 1, further comprising a selector unit (35), the selector unit being operable, in response to a selection of one of the content samples, to configure the playback apparatus for playback using the subtitle data file corresponding to the selected content sample.

3. The apparatus according to claim 1, wherein the video data (33) and the one or more subtitle data files (31) are stored in separate data files on the associated record carrier (32).

4. The apparatus according to claim 1, further comprising a storage unit (36) and wherein the request action is automatically provided by the apparatus upon initiation of playback, and where the content samples are fetched in the initiation process and stored on the storage unit for later access.

5. The apparatus according to claim 1, wherein the language setting of the apparatus is set to a second setting, and wherein the output unit is operable to output to the display unit, a signal representing the fetched content samples, the signal being generated based on the second language setting.

6. The apparatus according to claim 1, being adapted with playback capability of the DivX video format.

7. Method of operating a playback apparatus for playback of video data and corresponding one or more subtitle data files from an associated record carrier on which the one or more subtitle data files are stored, the apparatus being configured in accordance with a first language setting (40), the method comprising:
access (41) the one or more subtitle data files on the associated record carrier and fetch a content sample (42) of the subtitle data files;
output (43) to a display unit a signal representing the fetched content samples, the signal being generated based on the first language setting.

8. Integrated circuit (IC) for operating a playback apparatus in accordance with the method of claim 7.

9. Computer readable code for operating a playback apparatus in accordance with the method of claim 7.
